(19) United States
(12) Patent Application Publication
(10) Pub. No.: US 2025/0187541 A1
(43) Pub. Date: Jun. 12, 2025

(54) IN-VEHICLE DISPLAY OF EXTERIOR IMAGES TO MITIGATE BLIND SPOTS

(71) Applicant: CenturyLink Intellectual Property LLC, Denver, CO (US)

(72) Inventors: Dean Ballew, Sterling, VA (US); John R.B. Woodworth, Amissville, VA (US)

(73) Assignee: CenturyLink Intellectual Property LLC, Denver, CO (US)

(21) Appl. No.: 18/970,290

(22) Filed: Dec. 5, 2024

Related U.S. Application Data
(60) Provisional application No. 63/609,130, filed on Dec. 12, 2023.

(51) Int. Cl. B60R 1/22; G02B 27/00

(52) U.S. Cl. CPC B60R 1/22; G02B 27/0093; B60R 2300/202; B60R 2300/205; B60R 2300/304; B60R 2300/60; B60R 2300/802

(57) ABSTRACT

Systems and methods for in-vehicle display of exterior images to mitigate blind spots are described. A system may determine that a line of sight of a driver of a vehicle intersects an opaque portion of the vehicle, and in response, the system may display, on an interior surface of the opaque portion of the vehicle, an image of a portion of the exterior physical environment of the vehicle that is obscured by the opaque portion of the vehicle from the viewpoint of the driver. The system may perform parallax compensation on the image so that the image appears to be a view of the exterior physical environment from the viewpoint of the driver rather than from the viewpoint of the camera that captured the image.

### CROSS-REFERENCE TO RELATED APPLICATIONS

This application claims the benefits of U.S. Provisional Application No. 63/609,130 filed Dec. 12, 2023, entitled “In-Vehicle Display of Exterior Images to Mitigate Blind Spots,” which is incorporated herein by reference in its entirety.

### BACKGROUND

Automotive vehicles such as cars and trucks have structural features that may obscure the driver's view of the exterior physical environment of the vehicle, leading to blind spots. It is with respect to this general technical environment that aspects of the present disclosure are directed.

### SUMMARY

The present application describes a method comprising: determining a viewpoint of a driver of a vehicle; obtaining one or more images of a portion of a physical environment outside of the vehicle that is obscured, from the viewpoint of the driver, by a portion of the vehicle; applying parallax compensation to the one or more images based on the viewpoint of the driver to generate a compensated image; and displaying the compensated image using a display component inside the vehicle.

In some examples, and in combination with any of the above aspects and examples, the method further includes: detecting that a line of sight of the driver intersects the portion of the vehicle, where the computing system displays the compensated image in response to detecting that the line of sight of the driver intersects the portion of the vehicle.

In some examples, and in combination with any of the above aspects and examples, detecting that the line of sight of the driver of the vehicle intersects the portion of the vehicle includes: receiving, from an interior camera of the vehicle, information indicating a head position of the driver; estimating the line of sight of the driver based on the head position of the driver; and determining that the line of sight of the driver intersects the portion of the vehicle based on a three-dimensional representation of the vehicle.

In some examples, and in combination with any of the above aspects and examples, detecting that the line of sight of the driver of the vehicle intersects the portion of the vehicle includes: receiving, from an eye-tracking system of the vehicle, information indicating an eye position of the driver; estimating the line of sight of the driver based on the eye position of the driver; and determining that the line of sight of the driver intersects the portion of the vehicle based on a three-dimensional representation of the vehicle.

In some examples, and in combination with any of the above aspects and examples, displaying the compensated image using the display component includes projecting the compensated image onto an interior surface of the portion of the vehicle.

In some examples, and in combination with any of the above aspects and examples, displaying the compensated image using the display component includes displaying the compensated image using a display screen located on the portion of the vehicle.

In some examples, and in combination with any of the above aspects and examples, displaying the compensated image using the display component includes displaying the compensated image on a head-up display of the vehicle.

In some examples, and in combination with any of the above aspects and examples, determining the viewpoint of the driver includes: receiving, from an interior camera of the vehicle, information indicating a head position of the driver; and determining the viewpoint of the driver based on the head position of the driver.

In some examples, and in combination with any of the above aspects and examples, the method further includes: adjusting a visual characteristic of the compensated image based on a time of day.

In some examples, and in combination with any of the above aspects and examples, obtaining the one or more images includes receiving one or more live video images from one or more external cameras of the vehicle.

In some examples, and in combination with any of the above aspects and examples, obtaining the one or more images includes receiving two or more images from two or more external cameras of the vehicle, where the compensated image includes a merging of the two or more images.

In another aspect, the present technology includes a method that includes: detecting that a line of sight of a driver of a vehicle intersects an opaque portion of the vehicle; in response to detecting that the line of sight of the driver intersects the opaque portion of the vehicle: obtaining one or more images of a portion of a physical environment outside of the vehicle that is obscured, from a viewpoint of the driver, by the opaque portion of the vehicle, applying parallax compensation to the one or more images based on the viewpoint of the driver to generate a compensated image, and displaying the compensated image on a surface of the opaque portion of the vehicle.

In some examples, and in combination with any of the above aspects and examples, displaying the compensated image on the surface of the opaque portion of the vehicle includes projecting the compensated image onto the surface of the opaque portion of the vehicle.

In some examples, and in combination with any of the above aspects and examples, detecting that a line of sight of the driver of the vehicle intersects the opaque portion of the vehicle includes receiving information from a camera or an eye-tracking system.

In some examples, and in combination with any of the above aspects and examples, the method further includes determining the viewpoint of the driver based on information received from a camera or from an eye-tracking system.

In another aspect, the present technology includes a system that includes at least one processor; and memory, storing instructions that, when executed by the at least one processor, cause the system to perform a method, the method comprising: determining a viewpoint of a driver of a vehicle; obtaining one or more images of a portion of a physical environment outside of the vehicle that is obscured, from the viewpoint of the driver, by a portion of the vehicle; applying parallax compensation to the one or more images based on the viewpoint of the driver to generate a compensated image; and displaying the compensated image using a display component inside the vehicle.

In some examples, and in combination with any of the above aspects and examples, the method further includes: detecting that a line of sight of the driver intersects the portion of the vehicle, where the computing system displays the compensated image in response to detecting that the line of sight of the driver intersects the portion of the vehicle.

In some examples, and in combination with any of the above aspects and examples, detecting that the line of sight of the driver of the vehicle intersects the portion of the vehicle includes: receiving, from an interior camera of the vehicle, information indicating a head position of the driver; estimating the line of sight of the driver based on the head position of the driver; and determining that the line of sight of the driver intersects the portion of the vehicle based on a three-dimensional representation of the vehicle.

In some examples, and in combination with any of the above aspects and examples, detecting that the line of sight of the driver of the vehicle intersects the portion of the vehicle includes: receiving, from an eye-tracking system of the vehicle, information indicating an eye position of the driver; estimating the line of sight of the driver based on the eye position of the driver; and determining that the line of sight of the driver intersects the portion of the vehicle based on a three-dimensional representation of the vehicle.

In some examples, and in combination with any of the above aspects and examples, determining the viewpoint of the driver includes: receiving, from an interior camera of the vehicle, information indicating a head position of the driver; and determining the viewpoint of the driver based on the head position of the driver.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIGS. 1A-1D depict views of an interior of a vehicle according to aspects of the present application.

FIG. 2 is an example system for in-vehicle display of exterior images to mitigate blind spots according to aspects of the present application.

FIG. 3 is an example method for in-vehicle display of exterior images to mitigate blind spots according to aspects of the present application.

FIG. 4 is an example method for in-vehicle display of exterior images to mitigate blind spots according to aspects of the present application.

FIG. 5 is a block diagram of an example computing device that can be employed in relation to the present application.

### DETAILED DESCRIPTION

Automotive vehicles such as cars and trucks have structural features that may obscure the driver's view of the exterior physical environment of the vehicle, resulting in blind spots. For example, the supporting pillars of a vehicle may obscure the driver's view of areas alongside and/or behind the vehicle, making lane changes more difficult. For example, the hood of the vehicle may obscure the driver's view of an area directly in front of the vehicle such that a driver may not be able to see a hazard that is in front of the vehicle and low to the ground.

As described herein, systems and methods for displaying an image of a portion of an exterior physical environment of a vehicle inside the vehicle can be used to mitigate the effect of blind spots. In some examples, the system detects when a line of sight of a driver of the vehicle intersects an opaque portion of the vehicle, such as when the driver looks in the direction of an opaque pillar of the vehicle in preparation for making a lane change. When the system detects that the line of sight of the driver intersects the opaque portion of the vehicle, the system displays, on a surface of the portion of the vehicle, an image (e.g., a still image or a live video image) of a portion of the physical environment outside of the vehicle that is obscured by the opaque portion of the vehicle, thereby simulating an unobstructed view of the exterior physical environment. In some examples, the system displays the image on a head-up display of the vehicle.

In some examples, the vehicle includes one or more external-facing cameras to capture images of the portion of the exterior physical environment that is obscured by the opaque portion of the vehicle. In some examples, the system merges images from multiple external-facing cameras to generate the image that is displayed. In some examples, the system includes an eye-tracking system to detect the line of sight (e.g., the gaze direction) of the driver based on the driver's eye movements. In some examples, the system determines whether the line of sight intersects a particular portion of the vehicle using a three-dimensional representation of the vehicle in a coordinate system associated with the vehicle. In some examples, the three-dimensional representation of the vehicle includes an indication of pre-determined portions of the vehicle that may obscure a view of the driver, such as pillars of the vehicle or a hood of the vehicle, and the system determines whether a portion of the vehicle obscures the exterior physical environment from the viewpoint of the driver by determining whether an estimated line of sight of the driver or a vector intersects a pre-determined portion of the vehicle.

In some examples, the system includes an internal-facing camera to detect a head position of the driver, which can be used to estimate a viewpoint of the driver and/or to estimate a line of sight of the driver. In some examples, the system applies parallax compensation to the image (prior to or while displaying the image) based on a detected viewpoint of the driver to adjust the image so that it appears to be a view of the exterior physical environment from the current viewpoint of the driver rather than from the viewpoint of the camera that captured the image. In some examples, the system updates the parallax compensation of the image based on detected changes in the viewpoint of the driver (e.g., if the driver changes their head location or orientation).

In some examples, the system displays an image of a portion of the physical environment outside of the vehicle that is obscured by an opaque portion of the vehicle from the viewpoint of the driver whether or not the driver's line of sight intersects the opaque portion of the vehicle. That is, the system may display the image continuously rather than based on the line of sight of the driver.

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. In addition, all systems described with respect to the figures can comprise one or more machines or devices that are operatively connected to cooperate in order to provide the described system functionality. The following detailed description is therefore not to be taken in a limiting sense, and the scope of the present disclosure is defined by the appended claims and their equivalents.

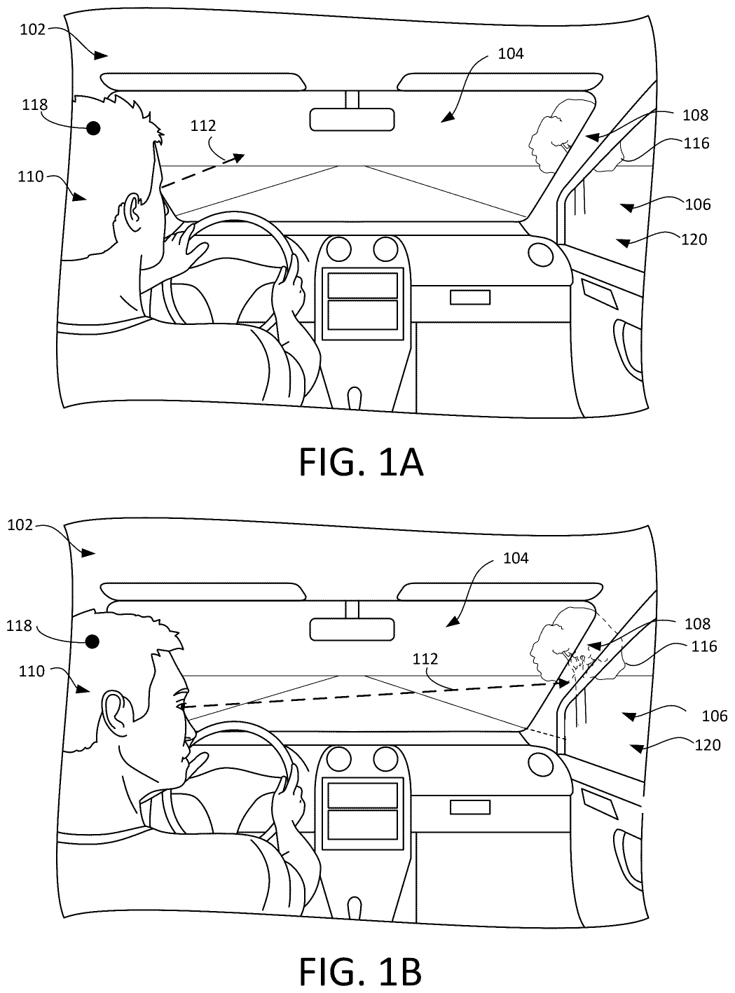

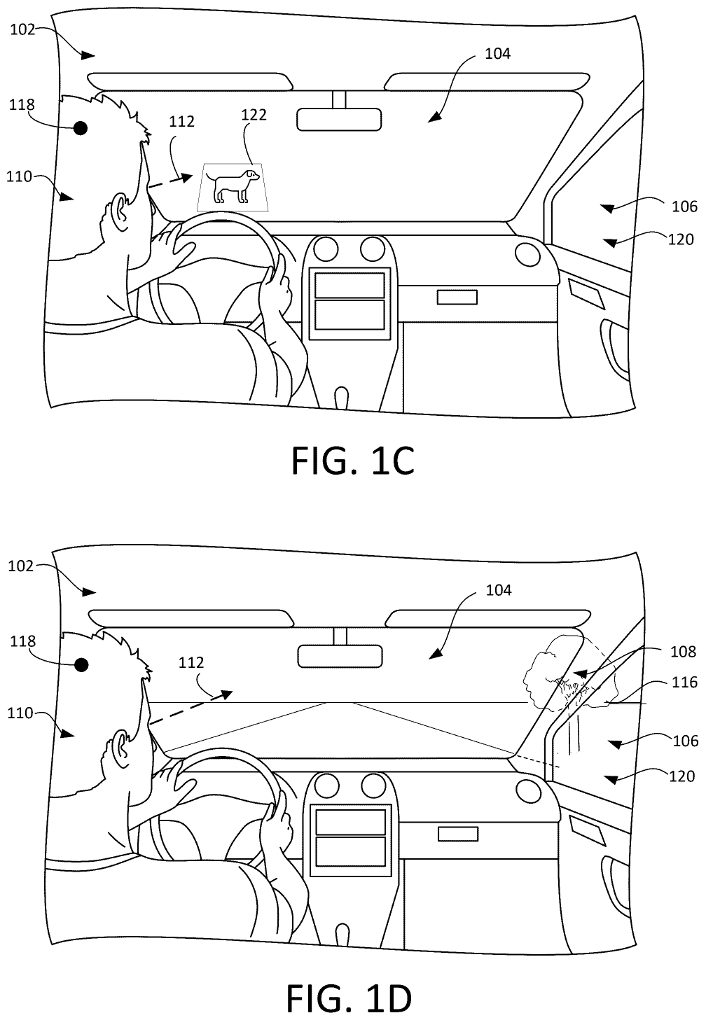

FIG. 1A depicts a first view of an interior of a vehicle 102 according to aspects of the present application. The vehicle 102 includes a transparent windshield 104 and a transparent passenger-side window 106 separated by an opaque right front pillar 108. In this view, a driver 110 of the vehicle 102 (e.g., a person sitting in the driver's seat of the vehicle 102 while the vehicle 102 is turned on) is looking forward through the windshield 104 such that a line of sight 112 of the driver 110 intersects a first area of the interior of the vehicle 102 (e.g., the windshield 104). The right front pillar 108 obscures, from a viewpoint 118 of the driver 110, a portion of a tree 116 that is in the exterior physical environment 120 (e.g., the physical environment around the vehicle 102). For example, a vector drawn between the viewpoint 118 and the obscured portion of the tree 116 intersects the right front pillar 108.

In some examples, the viewpoint 118 of the driver 110 corresponds to a location and/or orientation, in three-dimensional space, of the driver's head within the vehicle. In some examples, a driver 110 can change their line of sight without changing their viewpoint; for example, a driver can rotate their head to look in a different direction without changing the location and/or orientation of their head or can move their eyes to look in a different direction while keeping their head in the same location.

In the example of FIG. 1A, the line of sight 112 of the driver 110 does not intersect an opaque portion of the vehicle 102 and thus no image of the exterior physical environment 120 is displayed inside the vehicle.

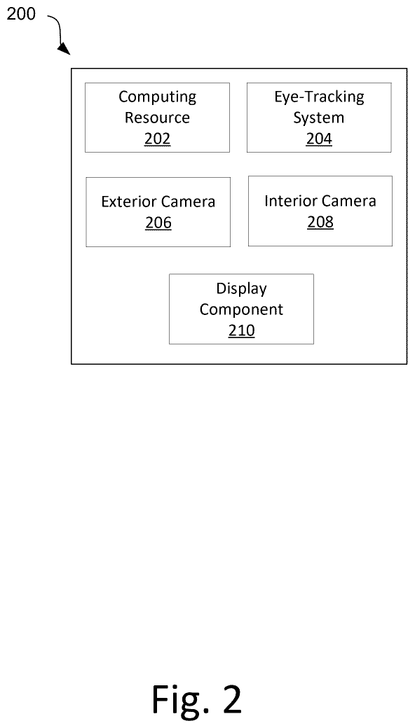

FIG. 1B depicts a second view of the interior of a vehicle 102 according to aspects of the present application. From FIG. 1A to FIG. 1B, the driver 110 has turned his head to the right such that the line of sight 112 of the driver intersects the right front pillar 108, which is an opaque portion of the vehicle. In some examples, a system (such as the blind spot mitigation system described with reference to FIG. 2) of the vehicle 102 detects that the line of sight of the driver intersects the right front pillar 108, and in response, the system obtains one or more images of a portion of the exterior physical environment 120 of the vehicle that is obscured by the right front pillar 108 from the perspective of the driver 110 (e.g., viewpoint 118). In some examples, the portion of the exterior physical environment 120 that is obscured from the viewpoint 118 of the driver 110 is determined by the system based on the detected line of sight 112 of the driver and/or based on the viewpoint 118 of the driver 110. As shown in FIG. 1B, the system displays the image of the portion of the physical environment that is obscured by the right front pillar 108 (e.g., an image including the obscured portion of the tree 116) on an interior (in-vehicle) surface of the right front pillar 108, thereby providing visibility, to the driver 110, of the obscured portion of the physical environment 120. For example, the system projects the image onto an interior surface of the right front pillar 108 using a projector or displays the image using a display screen that is embedded in or overlaid on the interior surface of the right front pillar 108. In some examples, the image that is displayed is a still image or a live video image captured by an external camera that is attached to the vehicle 102. In some examples, the image is a composite image based on multiple still images or multiple live video images captured by multiple exterior cameras attached to the vehicle 102. For example, the system may receive multiple images from multiple external cameras and merge the images into a single composite image.

In some examples, before displaying the image, the system applies parallax compensation to the image to adjust the image based on the viewpoint 118 of the driver 110. The system then displays the compensated image. Parallax compensation may be used to compensate for differences between the viewpoint of the driver and the viewpoint of the camera(s) that captures the image(s) such that the compensated image appears, to the driver, as it would appear if the driver 110 were directly viewing the portion of the physical environment that is included in the image (e.g., if the pillar 108 did not obscure the view of the physical environment from the viewpoint 118 of the driver). For example, parallax compensation may be used to compensate for the difference in the distance and/or angle from the driver's eyes to objects in the physical environment relative to the distance and/or angle from the camera's lens to such objects. <Inventors: please edit/augment description of parallax compensation as needed>

In some examples, the system adjusts a visual characteristic (e.g., a brightness and/or a color tone) of the image based on a time of day at which the image is displayed and/or based on ambient lighting. For example, the system may display images at a reduced brightness and/or using different color tones when the image is displayed at nighttime and/or when the ambient lighting is detected to be relatively dark relative to when the image is displayed during the day and/or when the ambient lighting is detected to be relatively bright.

The example of FIGS. 1A-1B depicts the case when a system detects that the driver's line of sight 112 intersects a right front pillar 108 of the vehicle 102 and in response, displays an image of a portion of the physical environment on the interior surface of the right front pillar 108. It should be understood, however, that the disclosure is not limited to this particular example. For example, the system may detect that the driver's line of sight intersects a different portion of the vehicle, such as a side pillar or rear pillar, and in response, display, on a surface of the different portion of the vehicle (e.g., on an interior surface of the side pillar or rear pillar), an image of a different portion of the physical environment that is obscured by the different portion of the vehicle from the viewpoint of the driver.

In some examples, the system detects that a line of sight of the driver intersects the hood or windshield of the vehicle, and in response, displays, on a head-up display of the vehicle, an image of a portion of the physical environment that is obscured by the hood of the vehicle (e.g., to enable the driver to see objects that are directly in front of the vehicle and not visible over the hood of the vehicle), such as depicted by the head-up display 122 in FIG. 1C (showing an image that includes a dog that is in front of the vehicle and obscured by the hood of the vehicle). In some examples, the system determines whether to display the image of the portion of the physical environment that is obscured by the hood of the vehicle based on detecting that the line of sight of the driver intersects the hood of the vehicle (or alternatively, the windshield of the vehicle) while the speed of the vehicle is below a threshold speed (e.g., rather than continuously displaying the image while the driver is driving the vehicle or displaying the image while the vehicle is traveling at a higher speed).

As previously mentioned, in some examples, the system displays the image of the portion of the exterior physical environment of the vehicle that is obscured by an opaque portion of the vehicle regardless of whether the driver's line of sight intersects the opaque portion of the vehicle, such as depicted in FIG. 1D. For example, the system may determine a viewpoint 118 of the driver 110 and continuously display, on an interior surface of the right front pillar 108, the portion of the exterior environment obscured by the right front pillar 108 from the viewpoint 118 of the driver regardless of whether the driver 110 is actually looking in the direction of the right front pillar 108. The system may perform parallax compensation on the image based on the viewpoint 118 of the driver. In this case, if the driver 110 subsequently turns his head or changes his gaze to look in the direction of the right front pillar 108, the compensated image is already displayed, thereby reducing potential display delays due to computational delays.

Additional details regarding a system that may be used to implement aspects of the above-described features is described with reference to FIG. 2.

FIG. 2 depicts an example of a blind spot mitigation system 200 with which examples of the present disclosure may be practiced. In the example of FIG. 2, blind spot mitigation system 200 includes a computing resource 202 that is in communication with various on-vehicle sensing and display component(s), which may include an eye-tracking system 204, one or more exterior cameras 206, one or more interior cameras 208, and/or one or more display components 210. In other examples, one or more of the elements of blind spot mitigation system 200 are omitted.

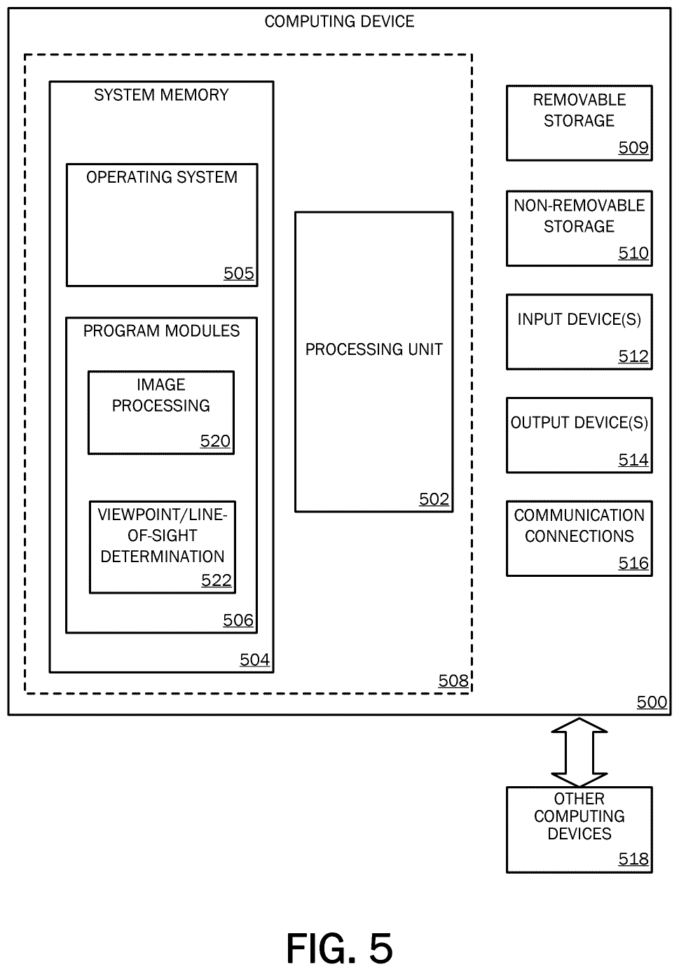

In some examples, computing resource 202 includes one or more first computing devices (e.g., computing device 500 described with reference to FIG. 5) that is/are included in the vehicle. In some examples, computing resource 202 includes one or more second computing devices that is/are remotely located from the vehicle and in communication with the first computing device(s) to enable the first computing device(s) to offload, to an external computing device, a portion of the processing associated with blind spot mitigation. Computing resource 202 may also comprise or be communicatively coupled with storage that, among other things, stores a three-dimensional model of the vehicle's interior (and/or exterior portions that can be viewed from the driver's seat, such as the vehicle's hood). The three-dimensional model, in examples, can be used in determining the driver's position relative to the one or more opaque surfaces of the vehicle.

Eye-tracking system 204 may include a camera and/or other sensing device that enables the eye-tracking system 204 to monitor eye movements of a driver of a vehicle. Computing resource 202 may receive, from eye-tracking system 204, signals representing movements of the driver's eyes. Computing resource 202 may use such signals to determine or estimate a viewpoint and/or a line of sight of the driver based on information received from the eye-tracking system 204. For example, computing resource 202 may estimate a line of sight of the driver by determining a direction of a normal vector extending from a detected pupil location(s) of the driver's eye(s). For example, computing resource 202 may estimate a viewpoint of the driver based on a position (e.g., location and/or orientation) of the driver's eyes.

Exterior camera(s) 206 may be attached to the exterior of the vehicle and configured to capture still or live (video) images of the physical environment outside of the vehicle. Computing resource 202 may receive images from the exterior camera(s) 206 and process such images to generate an image for display inside the vehicle, such as described with reference to FIGS. 1A-1D. For example, computing resource 202 may merge images received from multiple exterior cameras 206 to generate a composite image, apply parallax compensation to one or more images to generate a compensated image, and/or adjust a visual characteristic of one or more images before and/or while the image is displayed.

Interior camera(s) 208 may be attached to the interior of the vehicle and configured to capture live or still images of the interior of the vehicle. Computing resource 202 may receive images from the interior camera(s) 208 and use such images to determine or estimate a viewpoint and/or a line of sight of the driver based on a location and/or orientation of the driver's head within the vehicle. For example, computing resource 202 may estimate a line of sight of the driver by determining a direction of a normal vector extending from a face of the driver (or a portion thereof), and/or may estimate a viewpoint of the driver based on the location of a fixed point on the driver's head (e.g., the midpoint between the driver's eyes) within the vehicle.

Display component 210 may be configured to receive images from computing resource 202 and display the images on a portion of the interior of the vehicle, such as on an opaque portion of the interior of the vehicle (e.g., a pillar), and/or on a head-up display. Display component 210 may include a projector for projecting the image onto a surface of the interior of the vehicle and/or a display screen for displaying the image. For example, one or more interior surfaces of the vehicle may be wrapped or covered in a flexible display screen, such as a flexible organic light emitting diode (OLED) screen, or other curvable display technologies.

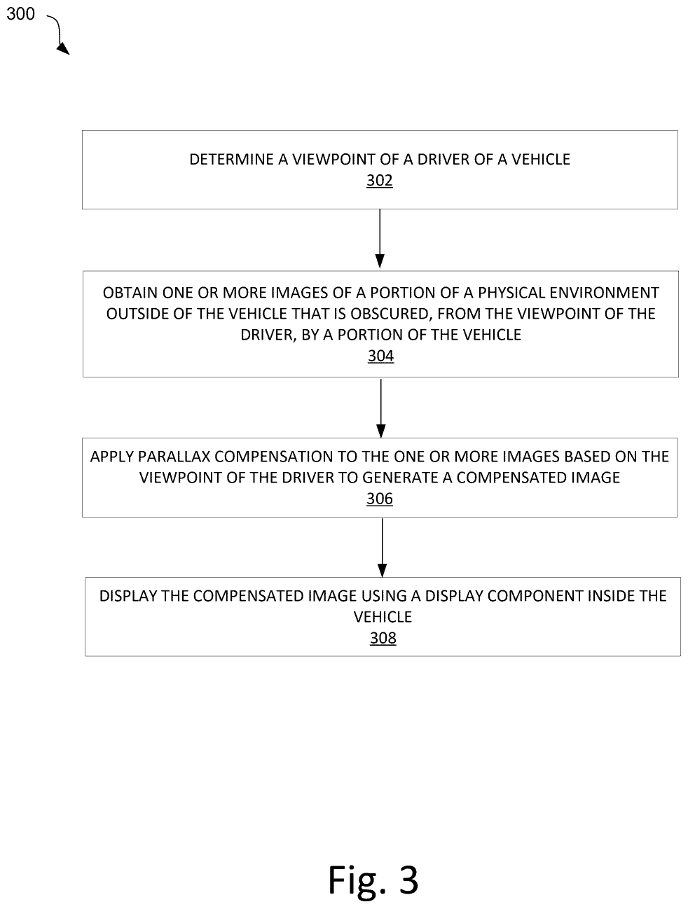

FIG. 3 depicts an example method 300 according to aspects of the present application. In examples, one or more of the operations of FIG. 3 can be performed by computing device, such as computing device 500 shown in FIG. 5, and/or by a system such as blind spot mitigation system 200 described with reference to FIG. 2.

At operation 302, a viewpoint of a driver of a vehicle is determined (e.g., viewpoint 118 of driver 110). In some examples, the viewpoint of the driver corresponds to a point (e.g., a location) in three-dimensional space inside the vehicle from which the driver may view the interior of the vehicle and/or exterior physical environment of the vehicle, such as a point corresponding to a location of the driver's head, eyes, ears, or other physical feature. In some examples, the viewpoint of the driver is assumed to be a static location relative to the interior of the vehicle (e.g., a location and/or orientation at which a driver's head is likely to be positioned), and determining the viewpoint of the driver includes obtaining the viewpoint of the driver from a storage element of a computing device. In some examples, the viewpoint may be estimated based on a sensed position of the driver's seat (which can be a rough indication of the driver's height). In some examples, the viewpoint of the driver is not assumed to be static and is instead dynamically determined by a computing device based on signals received from various components located inside the vehicle, such as an object/facial recognition system, an eye-tracking system and/or an interior camera. For example, a computing device may determine a current viewpoint of the driver based on a current head position of the driver, eye position of the driver, line of sight of the driver, or other physical information about the driver obtained via in-vehicle cameras or sensors. At operation 304, one or more images are obtained of a portion of a physical environment outside of the vehicle that is obscured, from the viewpoint of the driver, by a portion of the vehicle (such as right front pillar 108 or a hood of the vehicle). In some examples, the one or more images are live (video) or still images that are obtained (e.g., received) from one or more cameras mounted on the exterior of the vehicle. In some examples, the portion of the vehicle that obscures the portion of the physical environment is opaque.

At operation 306, parallax compensation is applied to the one or more images based on the viewpoint of the driver to generate a compensated image. In examples where multiple images are obtained, the images may be merged and parallax compensation may be applied to the images before, during, and/or after the merging of the images to generate a single compensated image. In some examples, the parallax compensation is applied to the one or more images by performing a parallax compensation algorithm on the one or more images. <Inventors: do you have examples of parallax compensation algorithms that could be applied? A quick web search was inconclusive>

At operation 308, the compensated image is displayed using a display component inside the vehicle. For example, the compensated image (which may be a live video that is parallax compensated based on the viewpoint of the driver) is displayed using a projector, head-up display, display screen, or other form of display component. In some examples, the compensated image is displayed on an interior surface of the portion of the vehicle. For example, the compensated image may be projected onto on an interior surface of a pillar of the vehicle.

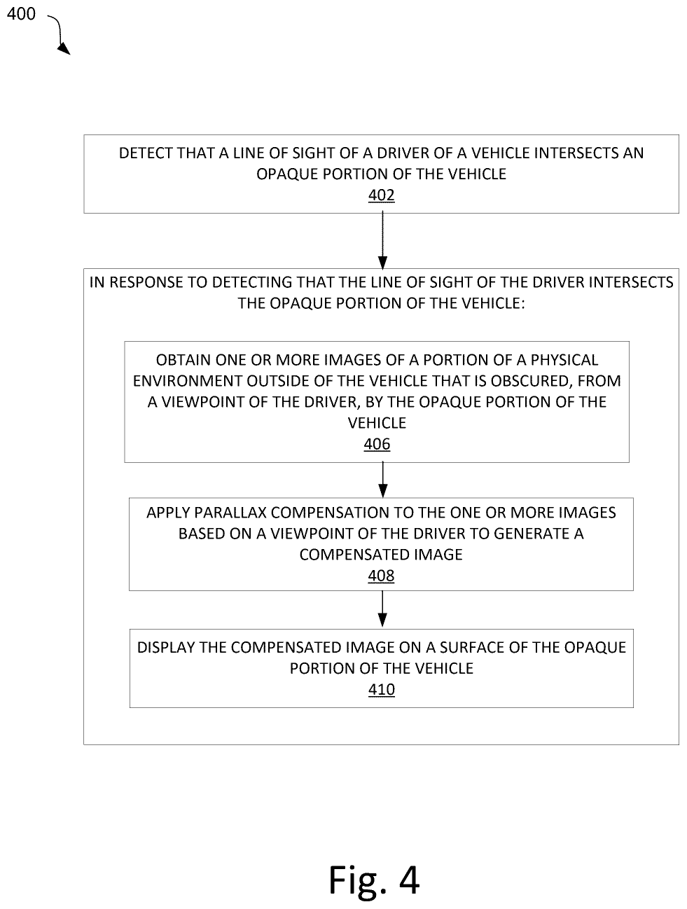

FIG. 4 depicts an example method 400 according to aspects of the present application. In examples, one or more of the operations of FIG. 4 can be performed by computing device, such as computing device 500 shown in FIG. 5, and/or by a blind spot mitigation system such as described with reference to FIG. 2.

At operation 402, it is detected that a line of sight of a driver of a vehicle intersects an opaque portion the vehicle. In some examples, a computing device detects that a line of sight of a driver intersects the opaque portion of the vehicle based on information received from an eye-tracking system and/or from one or more interior cameras. In some examples, a computing device estimates a line of sight of a driver by identifying, based on information received from an eye-tracking system and/or one or more interior cameras, a plane associated with the driver's face and/or eyes, determining a normal vector projecting from the plane, and determining that the normal vector intersects the opaque portion of the vehicle based on, for example, a three-dimensional representation of the vehicle. In some examples, the portion of the vehicle is a pre-defined portion of the vehicle (e.g., a pillar, a windshield, a hood). In some examples, the portion of the vehicle is an opaque portion of the vehicle.

In response to detecting that the line of sight of the driver intersects the portion of the vehicle, operations 406-410 are performed.

At operation 406, one or more images are obtained of a portion of a physical environment outside of the vehicle that is obscured, from the viewpoint of the driver, by the opaque portion of the vehicle. In some examples, the one or more images are live (video) or still images are obtained (e.g., received) from one or more cameras mounted on the exterior of the vehicle.

At operation 408, parallax compensation is applied to the one or more images based on the viewpoint of the driver to generate a compensated image, such as described with reference to operation 306 of method 300.

At operation 410, the compensated image is displayed on a surface of the opaque portion of the vehicle (e.g., using a display component), such as described with reference to operation 308 of method 300.

In some examples, after displaying the compensated image, in response to detecting that the line of sight of the driver does not intersect the portion of the vehicle (e.g., the driver is no longer looking at the portion of the vehicle) the compensated image ceases to be displayed.

FIG. 5 is a block diagram illustrating physical components (i.e., hardware) of a computing device 500 with which examples of the present disclosure may be practiced. The computing device components described below may be suitable for a computing device(s) implementing (or included in) the blind spot mitigation system of FIG. 2. In a basic configuration, the computing device 500 may include at least one processing unit 502 and a system memory 504. The processing unit(s) (e.g., processors) may be referred to as a processing system. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more program modules 506 suitable for running software applications to implement one or more of the components or systems described above with respect to FIGS. 1-4.

The operating system 505, for example, may be suitable for controlling the operation of the computing device 500. Furthermore, aspects of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 may perform processes including, but not limited to, one or more of the operations of the methods illustrated in FIGS. 3-4. For example, the program modules 506 may include an image processing module 520 that is configured to perform image processing on image(s) received from one or more external cameras of a vehicle, such as by merging images, performing parallax compensation on images, adjusting visual characteristics of images, and/or performing other types of image processing algorithms to improve the appearance of images displayed inside the vehicle. For example, the program modules 506 may include viewpoint/line-of-sight detection module 522 that is configured to determine (e.g., calculate, identify, obtain) a viewpoint of a driver of a vehicle and/or a line-of-sight of the driver of the vehicle based on information received from, for example, internal camera(s), an eye-tracking system of the vehicle, and/or other storage or computing resources.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 500 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 500 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used. The computing device 500 may include one or more communication connections 516 allowing communications with other computing devices 518, which may include cloud-based servers or remote computational resources. Examples of suitable communication connections 516 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500 and/or coupled with computing device 500. Computer storage media may be non-transitory and tangible and does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. Further, as used herein and in the claims, the phrase “at least one of element A, element B, or element C” is intended to convey any of: element A, clement B, element C, elements A and B, elements A and C, elements B and C, and elements A, B, and C.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed:

1. A method performed by a computing system, the method comprising:
determining a viewpoint of a driver of a vehicle;
obtaining one or more images of a portion of a physical environment outside of the vehicle that is obscured, from the viewpoint of the driver, by a portion of the vehicle;
applying parallax compensation to the one or more images based on the viewpoint of the driver to generate a compensated image; and
displaying the compensated image using a display component inside the vehicle.

2. The method of claim 1, further comprising:
detecting that a line of sight of the driver intersects the portion of the vehicle,
wherein the computing system displays the compensated image in response to detecting that the line of sight of the driver intersects the portion of the vehicle.

3. The method of claim 2, wherein detecting that the line of sight of the driver of the vehicle intersects the portion of the vehicle comprises:
receiving, from an interior camera of the vehicle, information indicating a head position of the driver;
estimating the line of sight of the driver based on the head position of the driver; and
determining that the line of sight of the driver intersects the portion of the vehicle based on a three-dimensional representation of the vehicle.

4. The method of claim 2, wherein detecting that the line of sight of the driver of the vehicle intersects the portion of the vehicle comprises:
receiving, from an eye-tracking system of the vehicle, information indicating an eye position of the driver;
estimating the line of sight of the driver based on the eye position of the driver; and
determining that the line of sight of the driver intersects the portion of the vehicle based on a three-dimensional representation of the vehicle.

5. The method of claim 1, wherein displaying the compensated image using the display component comprises projecting the compensated image onto an interior surface of the portion of the vehicle.

6. The method of claim 1, wherein displaying the compensated image using the display component comprises displaying the compensated image using a display screen located on the portion of the vehicle.

7. The method of claim 1, wherein displaying the compensated image using the display component comprises displaying the compensated image on a head-up display of the vehicle.

8. The method of claim 1, wherein determining the viewpoint of the driver comprises:
receiving, from an interior camera of the vehicle, information indicating a head position of the driver; and
determining the viewpoint of the driver based on the head position of the driver.

9. The method of claim 1, further comprising:
adjusting a visual characteristic of the compensated image based on a time of day.

10. The method of claim 1, wherein obtaining the one or more images comprises receiving one or more live video images from one or more external cameras of the vehicle.

11. The method of claim 10, wherein obtaining the one or more images comprises receiving two or more images from two or more external cameras of the vehicle, wherein the compensated image includes a merging of the two or more images.

12. A method performed by a computing system, the method comprising:
detecting that a line of sight of a driver of a vehicle intersects an opaque portion of the vehicle;
in response to detecting that the line of sight of the driver intersects the opaque portion of the vehicle:
obtaining one or more images of a portion of a physical environment outside of the vehicle that is obscured, from a viewpoint of the driver, by the opaque portion of the vehicle,
applying parallax compensation to the one or more images based on the viewpoint of the driver to generate a compensated image, and
displaying the compensated image on a surface of the opaque portion of the vehicle.

13. The method of claim 12, wherein displaying the compensated image on the surface of the opaque portion of the vehicle comprises projecting the compensated image onto the surface of the opaque portion of the vehicle.

14. The method of claim 12, wherein detecting that a line of sight of the driver of the vehicle intersects the opaque portion of the vehicle comprises receiving information from a camera or an eye-tracking system.

15. The method of claim 12, further comprising:
determining the viewpoint of the driver based on information received from a camera or from an eye-tracking system.

16. A system, comprising:
at least one processor; and
memory, storing instructions that, when executed by the at least one processor, cause the system to perform a method, the method comprising:
determining a viewpoint of a driver of a vehicle;
obtaining one or more images of a portion of a physical environment outside of the vehicle that is obscured, from the viewpoint of the driver, by a portion of the vehicle;
applying parallax compensation to the one or more images based on the viewpoint of the driver to generate a compensated image; and
displaying the compensated image using a display component inside the vehicle.

17. The system of claim 16, wherein the method further comprises:
detecting that a line of sight of the driver intersects the portion of the vehicle,
wherein the system displays the compensated image in response to detecting that the line of sight of the driver intersects the portion of the vehicle.

18. The system of claim 17, wherein detecting that the line of sight of the driver of the vehicle intersects the portion of the vehicle comprises:
receiving, from an interior camera of the vehicle, information indicating a head position of the driver;
estimating the line of sight of the driver based on the head position of the driver; and
determining that the line of sight of the driver intersects the portion of the vehicle based on a three-dimensional representation of the vehicle.

19. The system of claim 17, wherein detecting that the line of sight of the driver of the vehicle intersects the portion of the vehicle comprises:
receiving, from an eye-tracking system of the vehicle, information indicating an eye position of the driver;
estimating the line of sight of the driver based on the eye position of the driver; and
determining that the line of sight of the driver intersects the portion of the vehicle based on a three-dimensional representation of the vehicle.

20. The system of claim 16, wherein determining the viewpoint of the driver comprises:
receiving, from an interior camera of the vehicle, information indicating a head position of the driver; and
determining the viewpoint of the driver based on the head position of the driver.
